(19) United States
(12) Patent Application Publication
(10) Pub. No.: US 2020/0232415 A1
(43) Pub. Date: Jul. 23, 2020

(54) ENGINE WITH MINIMUM HEAT TRANSFERRED STRUCTURE

(71) Applicants: Hyundai Motor Company, Seoul (KR); Kia Motors Corporation, Seoul (KR)

(72) Inventors: Hong Kil BAEK, Seoul (KR); Seung Woo LEE, Seoul (KR); Tae Won LEE, Incheon (KR)

(73) Assignees: Hyundai Motor Company, Seoul (KR); Kia Motors Corporation, Seoul (KR)

(21) Appl. No.: 16/842,463

(22) Filed: Apr. 7, 2020

Related U.S. Application Data
(63) Continuation-in-part of application No. 16/136,555, filed on Sep. 20, 2018.

(30) Foreign Application Priority Data
Dec. 20, 2017 (KR) 10-2017-0176206

(51) Int. Cl. F02F 1/42; F02F 3/00; F02F 7/00

(52) U.S. Cl. CPC F02F 1/4285; F02F 7/0002; F02F 3/00

(57) ABSTRACT

An engine with a reduced cooling loss, may include a cylinder block, a piston and a cylinder head, wherein the engine displacement chamber is 300cc-700cc and an entire combustion chamber volume including a first volume of the cylinder block and a second volume of the cylinder head is defined between an inner surface of the cylinder head, a distal end of an intake valve mounted in the cylinder head when the intake valve is closed, and an upper surface of the piston positioned at a top-dead center of the engine in the cylinder block, wherein a compression ratio between an engine displacement chamber and the entire combustion chamber is 10.0 or more:1, and wherein the second volume of the cylinder head is 40%-70% of the entire combustion chamber volume.

### CROSS-REFERENCE TO RELATED APPLICATION

The present application is a Continuation-In-Part (CIP) of U.S. patent application Ser. No. 16/136,555, filed Sep. 20, 2018, which claims priority to Korean Patent Application No. 10-2017-0176206 filed on Dec. 20, 2017, the entire contents of which are incorporated herein for all purposes by these references.

### BACKGROUND OF THE INVENTION

### Field of the Invention

The present invention relates to an engine with a reduced cooling loss. More particularly, the present invention relates to an engine improved with a fuel consumption by reducing a cooling loss without a large design change of an engine.

### Description of Related Art

In a combustion chamber, a heat loss may be expressed as follows.

Q=hA(Tgas−Twall)Δt

Here, Q represents a heat transfer, h represents a heat transfer coefficient, A represents a heat exchange area of the combustion chamber, (Tgas-Twall) represents a temperature difference of a combustion gas and an internal wall, and Δt represents an elapsed time.

In other words, it may be confirmed that the heat loss due to the heat transfer is larger as the combustion chamber area is larger.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing the engine reducing the cooling loss and obtaining an enhancement of a fuel consumption by reducing a combustion chamber heat transfer area.

An engine with the reduced cooling loss according to various aspects of the present invention are directed to providing an engine in which a cylinder block and a cylinder head are combined, wherein an engine displacement chamber volume of the cylinder block is 300 cc-700 cc, and wherein a compression ratio between the volume of the engine displacement chamber and the volume of the entire combustion chamber is 10.0 or more:1.

The engine may be a gasoline engine.

The engine may include an intake valve and an exhaust valve, and a height from a bottom surface of the intake valve and the exhaust valve to a contact portion in contact with a valve seat may be 0.6 mm to 1.0 mm.

The bottom surface of the intake valve and the exhaust valve may be a flat shape.

According to the engine with the reduced cooling loss according to an exemplary embodiment of the present invention, without a design change of a conventional engine, the cooling loss may be reduced and the fuel consumption may be enhanced by reducing the combustion chamber heat transfer area.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of an engine with a reduced cooling loss according to an exemplary embodiment of the present invention.

FIG. 2 is a view of a valve applied to an engine with a reduced cooling loss according to an exemplary embodiment of the present invention.

FIG. 3 is a table showing an area and volume change of a combustion chamber according to a height reduction amount of a cylinder head.

FIG. 4 is a table showing an area and volume change of a combustion chamber according to a valve gauge height reduction.

FIG. 5 is a comparison table of a volume ratio of an engine with a reduced cooling loss according to an exemplary embodiment of the present invention and a conventional engine.

FIG. 6 is a comparison table of a combustion chamber cooling loss of an engine with a reduced cooling loss according to an exemplary embodiment of the present invention and a conventional engine.

FIG. 7 is a graph showing a fuel consumption improvement rate of an engine with a reduced cooling loss according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration.

As those skilled in the art would realize, the described embodiments may be modified in various different ways, all without departing from the spirit or scope of the present invention

Throughout the specification, the same reference numerals represent the same components.

In the drawings, the thickness of layers, films, panels, regions, etc., are exaggerated for clarity.

In addition, unless explicitly described to the contrary, the word “comprise” and variations such as “comprises” or “comprising”, will be understood to imply the inclusion of stated elements but not the exclusion of any other elements.

An exemplary embodiment of the present invention will hereinafter be described in detail with reference to the accompanying drawings.

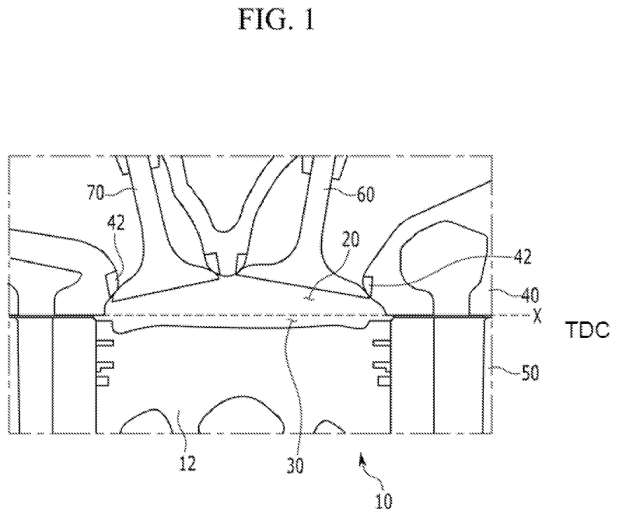

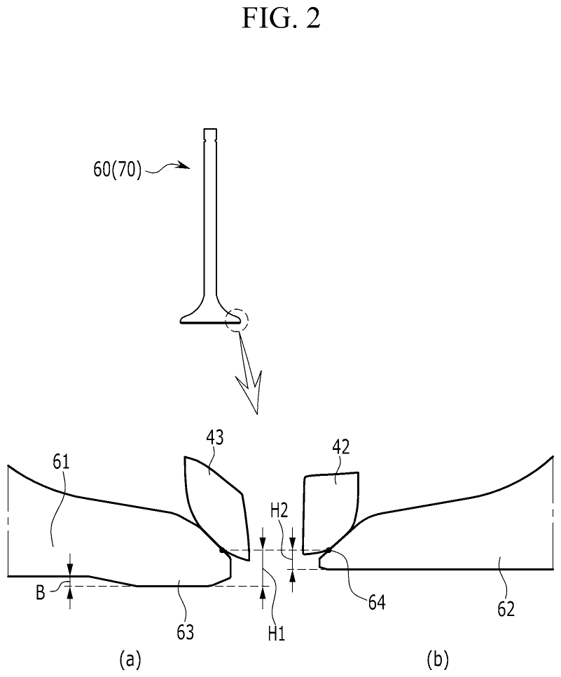

FIG. 1 is a cross-sectional view of an engine with a reduced cooling loss according to an exemplary embodiment of the present invention, and FIG. 2 is a view of a valve applied to an engine with a reduced cooling loss according to an exemplary embodiment of the present invention.

Referring to FIG. 1 and FIG. 2, the engine 10 with the reduced cooling loss according to an exemplary embodiment of the present invention is an engine in which the cylinder block 50 are the cylinder head 40 are coupled.

The volume 20 of the cylinder head 40 may be defined by a virtual surface X connecting a lower surface of the cylinder head 40 and a volume formed by the cylinder head 40.

The volume 30 of the cylinder block 50 may be defined by the virtual surface X connecting the lower surface of the cylinder head 40 and the volume formed by the cylinder block 50 and the piston 12.

The entire combustion chamber volume may be defined by a sum of the volume 20 of the cylinder head 40 and the volume 30 of the cylinder block 50 when a piston is positioned on a top-dead center (TDC) as shown in FIG. 1.

The volume of the engine displacement chamber of the cylinder block 50 is 300 cc-700 cc, and a compression ratio of the engine displacement chamber and the entire combustion chamber volume is 10.0 or more:1, wherein the engine displacement chamber is a chamber in which a piston of the engine reciprocates in the engine and is calculated from the bore, i.e., diameter of a cylinder and a stroke, i.e, a distance in which the piston travels between the top dead center (TDC) and the bottom dead center (BDC) in the engine.

The engine displacement chamber does not include the volume of the entire combustion chamber. In this configuration, if an engine has a compression ratio of 10:1 and the engine displacement chamber is 500 cc, then the entire combustion chamber volume is 50 cc.

The volume 20 of the cylinder head 40 may be 40%-70% of the entire combustion chamber volume.

The engine 10 with the reduced cooling loss according to an exemplary embodiment of the present invention is designed to reduce the cooling loss and to obtain the enhancement of the fuel consumption by reducing the combustion chamber area.

Also, the engine 30 may be a gasoline engine, and for ease of understanding, spark plugs and the like are omitted in the drawings.

The conventional diesel engine has a flat bottom so that there is not much a margin to reduce the volume of the cylinder head, therefore an application of the engine with the reduced cooling loss according to an exemplary embodiment of the present invention is not easy. Accordingly, the engine 30 may be the gasoline engine.

As the engine configured for reducing the cooling loss by the reducing the volume of the cylinder head, the engine of which the engine displacement chamber is 300 cc-700 cc is limited as an experiment.

Also, since the combustion chamber volume of the engine having the relatively low compression ratio is sufficiently large, a margin configured for improving the fuel consumption by reducing the combustion chamber area of the cylinder head is not large so that the engine with the reduced cooling loss according to an exemplary embodiment of the present invention may be limited to the engine of which the compression ratio is 10.0 or more.

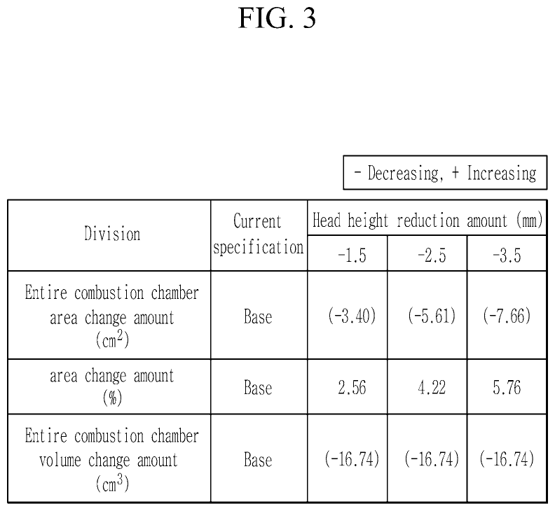

FIG. 3 is a table showing an area and volume change of a combustion chamber according to a height reduction amount of a cylinder head.

As an attempt to reduce the heat transfer area of the cylinder head 40, based on a conventional engine specification, the area of the entire combustion chamber, the area improvement amount, and the volume was obtained by reducing the height of the lower surface X of the cylinder head 40.

As shown in the table of FIG. 3, in the case reducing the relative height of the lower surface X of the cylinder head 40 by 3.5 mm, it is confirmed that the combustion chamber area is improved (reduced) with 5.76%.

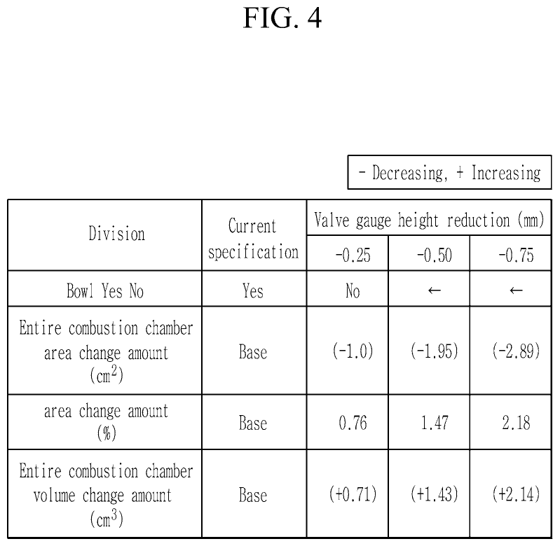

FIG. 4 is a table showing an area and volume change of a combustion chamber according to a valve gauge height reduction.

In the table of FIG. 4, the valve gauge height may be defined by a height from a bottom surface of the valve to a contact portion which is in contact with a valve seat.

As an attempt to reduce the heat transfer area of the cylinder head 40, the area of the entire combustion chamber and a surface improvement amount and the volume were obtained by reducing a valve gauge height H1 of the engine specification comparing to H2 of a conventional valve 61 in contact with a conventional valve seat 43.

As shown in the table of FIG. 4, when a bowl 63 of the conventional valve 61 is omitted and the valve gauge height is reduced by 0.75 mm (H1-H2), it is confirmed that the combustion chamber area is improved (reduced) by 2.18%.

The engine 10 includes an intake valve 60 and an exhaust valve 70, and the height from the bottom surface 62 of the intake valve 60 and the exhaust valve 70 to the contact portion 64 in contact with the valve seat 42 may be 0.6 mm to 1.0 mm.

Also, the bottom surface 62 of the intake valve 60 and the exhaust valve 70 may be the flat shape.

In general, the bowl is formed at the valve, and the bowl is formed to reduce the weight of the valve.

However, the valve 60 and 70 applied to the engine 10 with the reduced cooling loss according to an exemplary embodiment of the present invention does not include the bowl, that is, is formed of the flat shape, reducing the combustion chamber area. For example, in the valve 61 of the conventional engine in FIG. 2 (a), there is an effect that the combustion chamber area is reduced by omitting the protruding portion B of bowl 63.

In an exemplary embodiment of the present invention, the volume 20 of the cylinder head is the space enclosed by the virtual flat surface X connecting the lower surface of the cylinder head 40 and by the cylinder head x, the distal end of the intake valve 60 when the intake valve 60 is closed and a distal end of an exhaust valve 70 mounted in the cylinder head 40 when the exhaust valve 70 is closed.

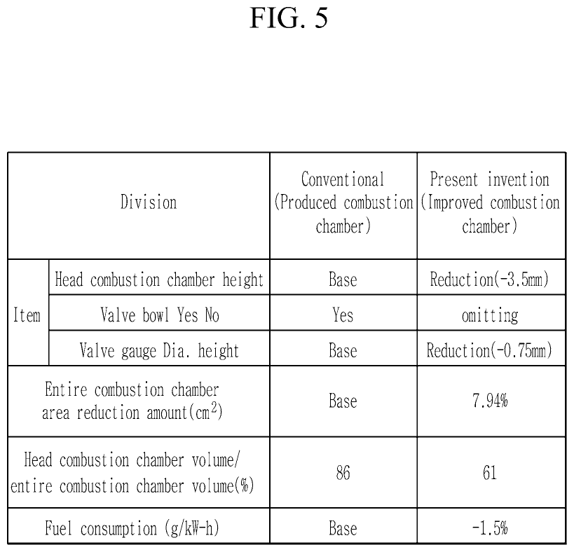

FIG. 5 is a comparison table of a volume ratio of an engine with a reduced cooling loss according to an exemplary embodiment of the present invention and a conventional engine.

Referring to the table of FIG. 5, when the relative height of the lower surface X of the cylinder head 40 is reduced by 3.5 mm, the bowl 63 of the conventional valve 61 is omitted, and the valve gauge height is reduced by 0.75 mm, it is confirmed that the combustion chamber heat transfer area is reduced by 7.94%, the ratio of the volume 20 of the cylinder head 40 for the entire combustion chamber volume is reduced from 86% to 61%, and the fuel consumption is improved by 1.5%.

However, the engine with the reduced cooling loss according to an exemplary embodiment of the present invention is not specified to the numerical values shown in the table of FIG. 5, but it is for the sake of convenience of understanding.

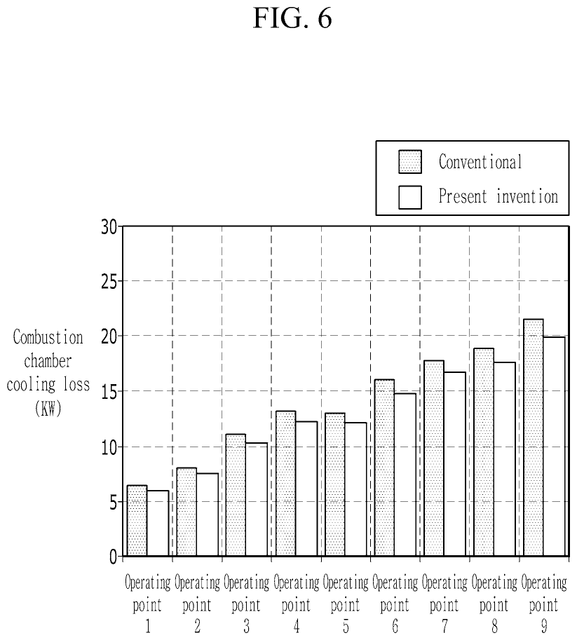

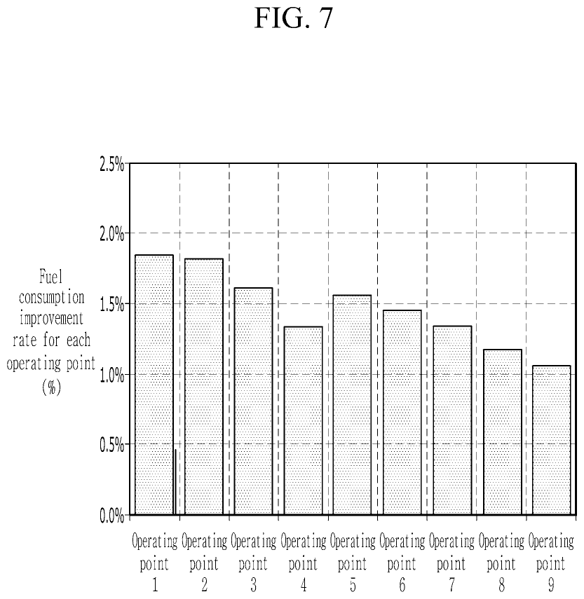

FIG. 6 is a comparison table of a combustion chamber cooling loss of an engine with a reduced cooling loss according to an exemplary embodiment of the present invention and a conventional engine, and FIG. 7 is a graph showing a fuel consumption improvement rate of an engine with a reduced cooling loss according to an exemplary embodiment of the present invention.

As shown in FIG. 6, when comparing the combustion chamber cooling loss according to each operating point, for example, a RPM increasing with the conventional engine, in the engine with the reduced cooling loss according to an exemplary embodiment of the present invention, it may be confirmed that the combustion chamber cooling loss characteristic is improved in the various operating points.

As shown in FIG. 7, when comparing the fuel consumption according to each operating point, for example, the RPM increasing with the conventional engine, in the engine with the reduced cooling loss according to an exemplary embodiment of the present invention, it may be confirmed that the fuel consumption is improved in the various operating points.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine with a reduced cooling loss, the engine comprising:
a cylinder block, a piston and a cylinder head,
wherein an engine displacement chamber is 300 cc-700 cc,
wherein an entire combustion chamber volume including a first volume of the cylinder block and a second volume of the cylinder head is defined between an inner surface of the cylinder head, a distal end of an intake valve mounted in the cylinder head when the intake valve is closed, and an upper surface of the piston positioned at a top-dead center of the engine in the cylinder block,
wherein a compression ratio between the engine displacement chamber and the entire combustion chamber is 10.0 or more:1,
wherein the second volume of the cylinder head is 40%-70% of the entire combustion chamber volume, and
wherein the engine includes the intake valve,
wherein the first volume of the cylinder block is a space enclosed by a virtual flat surface connecting a lower surface of the cylinder head and by the cylinder block and the upper surface of the piston in the engine, and
wherein the second volume of the cylinder head is a space enclosed by the virtual flat surface connecting the lower surface of the cylinder head and by the inner surface of the cylinder head, the distal end of the intake valve when the intake valve is closed; and
wherein the entire combustion chamber volume including a sum of the first volume of the cylinder block and the second volume of the cylinder head is determined in a state in which the piston in the engine is positioned at the top-dead center of the engine.

2. The engine with the reduced cooling loss of claim 1, wherein the engine is a gasoline engine.

3. The engine with the reduced cooling loss of claim 1,
wherein the engine includes the intake valve, and
wherein a height from a bottom surface of the intake valve to a contact portion in contact with a valve seat is 0.6 mm to 1.0 mm.

4. The engine with the reduced cooling loss of claim 3, wherein the bottom surface of the intake valve is flat.

5. The engine with the reduced cooling loss of claim 1,
wherein the engine includes an exhaust valve, and
wherein a height from a bottom surface of the exhaust valve to a contact portion in contact with a valve seat is 0.6 mm to 1.0 mm.

6. The engine with the reduced cooling loss of claim 5, wherein the bottom surface of the exhaust valve is flat.

7. The engine with the reduced cooling loss of claim 1,
wherein the second volume of the cylinder head is the space enclosed by the virtual flat surface connecting the lower surface of the cylinder head and by the cylinder head, the distal end of the intake valve when the intake valve is closed and a distal end of an exhaust valve mounted in the cylinder head when the exhaust valve is closed.
